(19) United States
(12) Patent Application Publication
(10) Pub. No.: US 2004/0241456 A1
(43) Pub. Date: Dec. 2, 2004

(54) Soil-resisting film formed article

(76) Inventors: Takeyuki Yamaki, Ikoma-gun (JP); Akira Tsujimoto, Ikoma-shi (JP); Kouichi Takahama, Amagasaki-shi (JP); Keisuke Tanaka, Ichihara-shi (JP); Hirokazu Tanaka, Ichihara-shi (JP); Shigeki Obana, Ichihara-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/490,647

(22) PCT Filed: Sep. 24, 2002
(86) PCT No.: PCT/JP02/09796

(30) Foreign Application Priority Data
Sep. 28, 2001 (JP) 2001-302073

(51) Int. Cl. B32B 17/10

(52) U.S. Cl. 428/429; 428/447

(57) ABSTRACT

An antifouling film coated article is provided, which has the capability of providing good antifouling property over an extended time period regardless of the amount of rainfall falling thereon. This coated article comprises a film of a silicone resin material formed on a substrate. A contact angle of water on the film is in a range of 5 to 30°, and an average surface roughness of the film is 5 nm or less. It is preferred that the silicone resin material is a composition containing colloidal silica and a silicone resin that is at least one selected from a partial hydrolysate and full hydrolysate of 4-functional hydrolyzable organosilane. This composition may further contain organic zirconium and/or an optical semiconductor material.

### TECHNICAL FIELD

The present invention relates to an antifouling film coated article having the capability of providing good antifouling property over an extended time period regardless of the amount of rainfall falling thereon.

### BACKGROUND ART

In the past, a film containing a photocatalytic semiconductor material such as TiO₂, ZnO and SnO₂ is proposed as antifouling film (for example, Japanese Patent Publications No. 2756474 and No. 2924902).

The film containing the photocatalytic semiconductor material exhibits a self-cleaning effect of decomposing carbon-based contaminants (for example, carbon components included in exhaust gas of diesel cars or tar of cigarette) adhered to its film surface, odor eliminating effect of decomposing bad-smell components such as amine compounds or aldehyde compounds, antibacterial effect of preventing the propagation of bacteria such as E. coli bacteria and Staphylococcus aureus, and mildew-proof effect. It is thought that when light (ultraviolet light) having an excitation wavelength (for example, 400 nm) is irradiated to the film containing the photocatalytic semiconductor material, active oxygen is generated to result in oxidation decomposition of organic materials.

In addition, when the ultraviolet light is irradiated to the film containing the photocatalytic semiconductor material, moisture adhered to the film surface or the moisture in the air are changed to hydroxy radicals by the photocatalysis, so that the hydroxy radicals decompose water-repellent organic materials. As a result, since a contact angle of water on the film surface decreases, an effect of improving wettability (hydrophilicity) of water on the film surface can be obtained. By this improvement of hydrophilicity, when the coated article is used as an indoor member, a defogging effect of preventing fogging of glass or mirror is expected. On the other hand, when the coated article is used as an outdoor member, the antifouling effect of allowing rain water to wash away contamination is expected. In addition, the photocatalytic semiconductor material has the antistatic function, which is useful to improve the antifouling property.

It has been thought that since the film containing the photocatalytic semiconductor material has a hydrophilic surface with 50 or less of the contact angle of water thereon, the antifouling effect is obtained by, for example, rain water falling thereon. However, when the water amount falling on the film surface decreases, the antifouling effects is not obtained sufficiently. In addition, there is a case that contamination appears along flows of rain water on the film surface, so that noticeable contamination remains on the film surface. In these viewpoints, the conventional antifouling film coated articles still have plenty of room for improvement.

### SUMMARY OF THE INVENTION

Therefore, in view of the above problems, a concern of the present invention is to provide an antifouling film coated article having the capability of maintaining good antifouling property regardless of the amount of rainfall falling thereon.

That is, the antifouling film coated article of the present invention has a film of a silicone resin material on a substrate, which is characterized in that a contact angle of water on the film is in a range of 5 to 30°, preferably 8 to 25°, and an average surface roughness of the film is 5 nm or less. Thereby, excellent antifouling property is achieved regardless of the amount of water adhered to the film surface. In particular, when the coated article is used outside, good antifouling property is obtained.

In the antifouling film coated article according to a preferred embodiment of the present invention, the silicone resin material of the film is a composition containing colloidal silica and a silicone resin that is at least one of a partial hydrolysate and full hydrolysate of 4 functional hydrolyzable organosilane. In this case, since hydrophilicity of the film is maintained by the colloidal silica, it is easy to stably keep the contact angle of water in the above range over an extended time period. In particular, it is preferred that the above composition contains the colloidal silica such that a weight ratio of a solid content of silica to the solid content 1 in terms of condensate of the silicone resin is in a range of 0.01 to 9.

In the antifouling film coated article of the present invention, it is also preferred that the above composition further contains an organic zirconium. In this case, the contact angle of water on the film can be easily controlled. In particular, it is preferred that the composition contains 0.1 to 10 parts by weight of the organic zirconium in terms of ZrO₂ with respect to 100 parts by weight of the entire solid contents of the composition. In this case, an effect of maintaining the contact angle of water is further improved. In addition, gelation or agglomeration of the composition can be prevented during the film formation. As a result, the film formation becomes easy.

In the antifouling film coated article of the present invention, it is further preferred that the composition contains an optical semiconductor material. In this case, since water-repellent organic materials are decomposed by the photocatalysis of the optical semiconductor material, it is possible to stably maintain the contact angle of water on the film surface over the extended time period. Moreover, in the case of using the antifouling film coated article at the outdoors, an antifouling effect can be obtained by the photocatalysis when rain water adheres to the surface of the coated article.

In particular, when the composition described above contains the optical semiconductor material, it is preferred that a compounding ratio by weight of the optical semiconductor material to the total weight 1 of the solid content in the terms of condensate of the silicone resin and silica as the solid content of the colloidal silica is 0.01 or more and less than 0.4. In this case, it is possible to obtain sufficient photocatalysis effect, and stably maintain the contact angle of water on the film surface. Furthermore, good transparency and strength of the film can be realized.

In the antifouling film coated article of the present invention, it is also preferred that the composition contains the optical semiconductor material such that a compounding ratio by weight of the optical semiconductor material to the solid content 1 in terms of condensate of the silicone resin is 0.01 or more and less than 0.4, and further contains 0.1 to 10 parts by weight of the organic zirconium in terms of ZrO₂ with respect to 100 parts by weight of the entire solid contents of the composition. In this case, it is possible to obtain excellent photocatalysis as well as increased film strength. It becomes easy to maintain the contact angle of water. Moreover, gelation or agglomeration of the composition can be prevented during the film formation, so that the film formation becomes easy.

In the antifouling film coated article of the present invention, it is preferred that the substrate is made of glass. In this case, the coated article having good antifouling property can be provided.

### BRIEF DESCRIPTION OF THE DRAWINGS

FIG. 1 is a photograph showing an appearance of an antifouling film coated article of Example 1 according to the present invention, which was observed after being exposed to outdoor environment for 12 months;

FIG. 2 is a photograph showing an appearance of an antifouling film coated article of Comparative Example 3, which was observed after being exposed to outdoor environment for 12 months; and

FIG. 3 is a photograph showing an appearance of an antifouling film coated article of Comparative Example 1, which was observed after being exposed to outdoor environment for 12 months.

### BEST MODE FOR CARRYING OUT THE INVENTION

An antifouling film coated article of the present invention has a film of a silicone resin material on a substrate, wherein a contact angle of water on the film is in a range of 5 to 30°, preferably 8 to 25°, and an average surface roughness of the film is 5 nm or less.

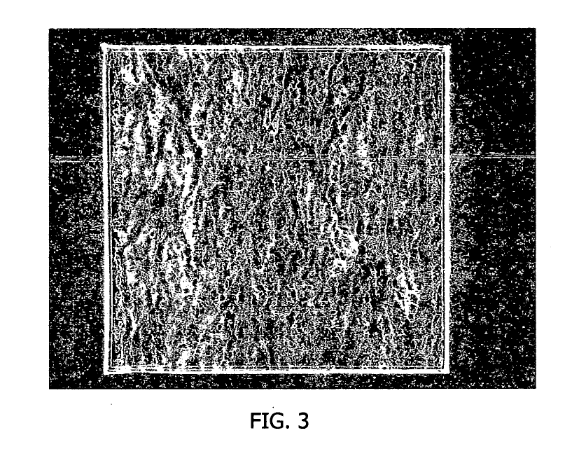

In a case that the contact angle is less than 5°, even when a small amount of water adheres to the film, drops of water spread to the film surface. When the water drops do not run off therefrom, relatively large scale-like contamination remains on the film surface, as shown in FIG. 2. On the other hand, when the water drops run off, the contamination remains along flows of water on the film surface, as shown in FIG. 3. Since contaminants localize at outer edges of the water drops, a difference in the amounts of contaminants between the interior and the outer edge of the respective water drop is recognized as a contrast of contamination. In the case that the contact angle of water exceeds 30°, even when a large amount of water adheres to the film, a layer of water is not formed on the film surface. In this case, the contaminants adhered to the film surface are hard to run off, so that they are pooled on the film surface to cause the contamination. In the present invention, when the contact angle of water is in the range of 8 to 25°, it is possible to obtain further improved antifouling property.

At a substantially initial condition that the coated article is used for an intended purpose, the film has the contact angle of 5 to 30°. In particular, when an optical semiconductor material described later is compounded, the “initial condition” means a condition that it is initially used under light irradiation. In the present invention, it is also preferred that the contact angle of water on the film surface is kept in the range of 5 to 30° for a long time period (preferably 6 months or more) from first use.

On the other hand, when the average surface roughness of the film exceeds 5 nm, contaminants are easy to adhere to the film surface. That is, even when a layer of water is formed on the film surface, the contaminants are caught by the bumpy surface of the film, so that they are hard to run off. As a result, the contaminants included in the water easily remain on the film surface. A lower limit of the average surface roughness is not specifically limited. When the contact angle of water is kept in the above range, smaller average surface roughness is favorable.

It is preferred that the silicone resin material constructing the antifouling film of the antifouling film coated article of the present invention is a composition containing colloidal silica and a silicone resin that is at least one of a partial hydrolysate and full hydrolysate of 4-functional hydrolyzable organosilane. A state of the silicone resin in this composition is not specifically limited. For example, it may be in a solution state or a dispersed (colloidal) state. By using the 4-functional hydrolyzable organosilane with four reactive substituents (hydrolyzable substituents) on silicon atom, it is possible to moderately give hydrophilicity to the film, stably keep the contact angle of water on the film surface, and also provide sufficient hardness to the film. As the 4-functional hydrolyzable organosilane, for example, a 4-functional organoalkoxysilane shown by the following chemical formula (1) is available.

Si(OR¹)₄ (1)

In the above formula, the functional group “R¹” of the alkoxyl group “OR¹” is a monovalent hydrocarbon group, preferably a monovalent hydrocarbon group having the carbon number of 1 to 8, for example, an alkyl group such as methyl group, ethyl group, propyl group, butyl group, pentyl group, hexyl group, heptyl group and octyl group. In these hydrocarbon groups, when the carbon number is 3 or more, it is possible to use a group having straight chain such as n-propyl group and n-butyl group, or a group having branched chain such as isopropyl group, isobutyl group and t-butyl group. In addition, different kinds of the alkoxyl group “OR¹” may be bonded to the silicon atom in one molecule. Moreover, an organoalkoxysilane obtained by partial hydrolysis of the 4-functional organoalkoxysilane described above may be compounded.

If necessary, as shown by the following chemical formula (2), an organoalkoxysilane not having four functional groups may be used in addition to the 4-functional hydrolyzable organosilane described above.

R²₄₋ₙSi(OR¹)ₙ (2) (“n” is an integer of 1 to 3.)

In the above formula, the functional group “R¹” of the alkoxyl group “OR¹” is the same as the 4-functional organoalkoxysilane described above. The functional group “R²” may be the same as the functional group “R¹”. Alternatively, it may have a structure shown by the following chemical formula (3)˜(5). Different kinds of the functional group “R²” may be bonded to the silicon atom in one molecule. 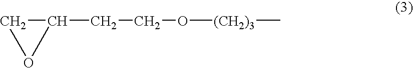 CH₂═CHCH₂—O—(CH₂)₃— (4)

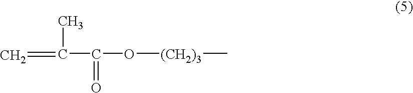

Specifically, as the hydrolyzable organosilane, it is possible to use γ-glycidoxypropyl trimethoxysilane shown by the following chemical formula (6), γ-glycidoxypropyl methyldimethoxysilane shown the following chemical formula (7), γ-metacryloxypropyl trimethoxysilane shown by the following chemical formula (8), and γ-metacryloxypropyl-methyldimethoxysilane shown by the following chemical formula (9).

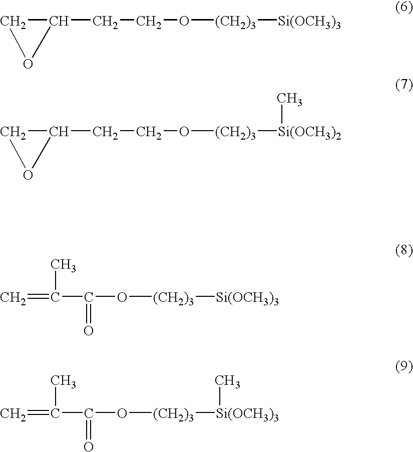

By mixing the above-described hydrolyzable organosilane with water, and hydrolyzing a resultant mixture, the silicone resin of the partial hydrolysate or the full hydrolysate is obtained. The amount of water to be added to hydrolyze the hydrolyzable organosilane can be determined such that a mole equivalent (H₂O/OR²) of water (H₂O) to the hydrolyzable group (in the case of organoalkoxysilane, it is alkoxyl group (OR²)) of the hydrolyzable organosilane is within a range of 0.3 to 5.0, preferably 0.35 to 4.0, and more preferably 0.4 to 3.5. When this value is less than 0.3, there is a fear that the progression of hydrolysis becomes insufficient, so that a reduction in toughness of the cured film occurs. On the other hand, when this value is more than 5.0, there is a tendency that gelation of the obtained silicone resin proceeds in a short time. In this case, the storage stability may deteriorate.

If necessary, a catalyst may be used at the hydrolysis. As the catalyst, it is preferred to use an acidic catalyst to reduce the production time. For example, the acidic catalyst comprises an organic acid such as acetic acid, monochloroacetic acid, citric acid, benzoic acid, dimethylmalonic acid, formic acid, propionic acid, glutaric acid, glycolic acid, maleic acid, malonic acid, toluenesulfonic acid and oxalic acid, an inorganic acid such as silane halide, nitric acid and hydrochloric acid, and an acidic sol filler such as acidic titania sol and acidic colloidal silica. At least one of these acidic catalysts can be used. If necessary, this hydrolysis may be performed at a heating temperature of 40 to 100° C.

In addition, the hydrolysis of organoalkoxysilane may be performed in the presence of a diluent solvent in addition to water. As the diluent solvent, for example, it is possible to use a lower aliphatic alcohol such as methanol, ethanol, isopropanol, n-butanol, and isobutanol, ethylene glycol derivative such as ethylene glycol, ethylene glycol monobutyl ether, acetic ethyl glycol monoethyl ether, diethylene glycol derivative such as diethylene glycol and diethylene glycol monobutyl ether, and a hydrophilic organic solvent such as diacetone alcohol. At least one of these diluent solvents can be used.

In addition, as the diluent solvent, at least one of toluene, xylene, hexane, heptane, ethyl acetate, butyl acetate, methyl ethyl ketone, methyl isobutyl ketone, methyl ethyl ketone oxime may be used together with the hydrophilic organic solvent described above.

It is preferred that a weight-average molecular weight of the silicone resin composed of the partial hydrolysate or the full hydrolysate of organoalkoxysilane is within a range of 500 to 1000 in terms of polystyrene. When the weight-average molecular weight is less than this range, the hydrolysate may be unstable. On the other hand, when the weight-average molecular weight exceeds the above range, there is a fear that sufficient film hardness can not be maintained.

On the other hand, as the colloidal silica, for example, it is possible to use a water-dispersible colloidal silica or a colloidal silica dispersible in hydrophilic organic solvent such as alcohol. Generally, such a colloidal silica contains 20 to 50 wt % of silica as the solid content. From this value, the compounding amount of silica can be determined. The water-dispersible colloidal silica is usually obtained from water glass. A marketed production thereof is available. On the other hand, the colloidal silica dispersible in hydrophilic organic solvent can be readily prepared by substituting water of the water dispersible colloidal silica with an organic solvent. A marketed production thereof is also available.

In the organic-solvent dispersible colloidal silica, as the organic solvent in which the colloidal silica is dispersed, for example, it is possible to use a lower aliphatic alcohol such as methanol, ethanol, isopropanol, n-butanol, and isobutanol, ethylene glycol derivative such as ethylene glycol, ethylene glycol monobutyl ether, acetic ethylene glycol monoethyl ether, diethylene glycol derivative such as diethylene glycol and diethylene glycol monobutyl ether, or a hydrophilic organic solvent such as diacetone alcohol. One of these organic solvents or a mixture of thereof may be used. In addition to the hydrophilic organic solvent, at least one selected from toluene, xylene, hexane, heptane, ethyl acetate, butyl acetate, methyl ethyl ketone, methyl isobutyl ketone, methyl ethyl ketone oxime can be used.

It is preferred that a compounding amount of the colloidal silica in the composition for film formation is determined such that a weight ratio of a solid content of silica to the solid content (1) in terms of condensate of the silicone resin is in a range of 0.01 to 9. When the compounding amount is less than this range, the effect of maintaining moderate hydrophilicity of the film may lower. On the other hand, when the compounding amount exceeds the above range, there is a tendency of reducing the film strength.

In the case of using the composition containing the silicone resin and the colloidal silica described above, the hydrophilicity of the film surface is maintained by the colloidal silica having good hydrophilicity, so that the contact angle of water on the film can be favorably kept over the extended time period. In addition, the film hardness can be increased, and improvements in surface smoothness and crack resistance can be obtained.

When using the water dispersible colloidal silica, it is possible to use water existing as disperse medium in the water dispersible colloidal silica for the hydrolysis of the hydrolyzable organosilane. That is, when the hydrolyzable organosilane and the water dispersible colloidal silica are compounded at the preparation of the composition for film formation, water of the disperse medium is used to hydrolyze the hydrolyzable organosilane and generate the silicone resin. As a result, the composition containing the silicone resin can be obtained. In addition, the colloidal silica works as acidic catalyst at the hydrolysis.

In the case of using the organic-solvent dispersible colloidal silica, when it is added at the hydrolysis of the hydrolyzable organosilane, the colloidal silica works as the acidic catalyst.

If necessary, another inorganic filler may be used. For example, it is possible to use a powder-like silica such as aero gel or an inorganic filler such as inorganic oxides of the optical semiconductor. These are favorable from the viewpoints of chemical stability such as resistance to solvent and acid resistance, and dispersibility in the silicone resin. One of these fillers may be used by itself. Alternatively, two or more of them may be used.

It is preferred that the composition for forming the film of the antifouling film coated article of the present invention further contains an optical semiconductor material. That is, when the film containing the optical semiconductor material receives light having an excitation wavelength (for example, ultraviolet having the wavelength of 400 nm), active oxygen such as superoxide ions or hydroxy radicals is generated from the moisture in the air or the moisture adhered to the film surface. Since this active oxygen results in oxidation decomposition of organic materials, it is possible to obtain a self-cleaning effect of decomposing carbon-based contaminants (for example, carbon components included in exhaust gas of diesel cars or tar of cigarette) adhered to the film surface, odor eliminating effect of decomposing bad-smell components such as amine compounds or aldehyde compounds, antibacterial effect of preventing the occurrence of bacteria such as E. coli bacteria and Staphylococcus aureus, and mildew proof effect. In addition, since water-repellent organic materials adhered to the film surface or included in the film are decomposed by the photocatalysis, the contact angle of water on the film surface can be stably maintained over the extended time period. In particular, when the coated article of the present invention is used as an outdoor member, the above-described photocatalysis is brought by rain water falling on the coated article, so that the antifouling effect is obtained. Moreover, amounts of OH groups on the film surface are increased by the photocatalysis of the optical semiconductor, thereby maintaining the hydrophilicity of the film surface. By allowing the film surface to have hydrophilicity, a surface resistance value of the film becomes small. Therefore, the film possesses the antistatic property.

As the optical semiconductor material, it is possible to use a single metal oxide such as titanium oxide, zinc oxide, tin oxide, iron oxide, zirconium oxide, tungsten oxide, chromium oxide, molybdenum oxide, ruthenium oxide, germanium oxide, lead oxide, cadmium oxide, copper oxide, vanadium oxide, niobium oxide, tantalum oxide, manganese oxide, cobalt oxide, rhodium oxide, nickel oxide and rhenium oxide, and strontium titanate. In these compounds, it is preferred to use the single metal oxide from the viewpoint of the practical use. In those single metal oxides, it is particularly preferred to use titanium oxide because there are advantages in photocatalyst performance, safety, ready availability and cost performance. By the way, titanium oxide having the crystal form of anatase type exhibits excellent photocatalyst performance and an effect of accelerating the curing of the film. In addition, the contact angle of water on the film can be maintained for a longer time period, and the photocatalyst performance such as decomposition appears in a short time. One of these optical semiconductor materials may be used by itself. Alternatively, two or more of them may be used. Additionally, it is preferred to dope a metal element such as silver, copper, iron and nickel of accelerating charge separation of the optical semiconductor into the optical semiconductor material. A raw material that can finally be converted into a compound having the optical semiconductor property, or a derivative of the compound such as titanium alkoxide may be added.

When adding the optical semiconductor material to the composition for film formation, the optical semiconductor material can be in a state dispersible in the composition, for example, power, fine powder, or sol particles dispersed in solution. When selecting a sol state such as the sol particles dispersed in solution, and particularly the sol state having a pH value of 7 or less, it is possible to further accelerate the curing of the film, and therefore improve the convenience in use. When using the optical semiconductor material in the sol state, the dispersion medium is not specifically limited, but it has the capability of uniformly dispersing fine particles of the optical semiconductor material therein. For example, water or an organic solvent may be used by itself. Alternatively, a mixed dispersion medium of water and the organic solvent may be used.

As the mixed dispersion medium of water and the organic solvent, it is possible to use a mixed dispersion medium of water and one or more of hydrophilic organic solvents, for example, a lower aliphatic alcohol such as methanol, ethanol, isopropanol, n-butanol, and isobutanol, ethylene glycol derivative such as ethylene glycol, ethylene glycol monobutyl ether, acetic ethylene glycol monobutyl ether, diethylene glycol derivative such as diethylene glycol and diethylene glycol monobutyl ether, and diacetone alcohol. In the case of using the mixed dispersion medium of water and methanol, there are advantages in dispersion stability of optical semiconductor fine particles and drying characteristics of the dispersion medium at the film formation.

When a sol-like optical semiconductor material having acid stability is used in the presence of only water or the mixed dispersion medium of water and the organic solvent, the sol-like optical semiconductor material works as the acid catalyst for hydrolyzing the hydrolyzable organosilane, and water existing as the dispersion medium is used for the hydrolysis of the hydrolyzable organosilane. That is, when the hydrolyzable organosilane and the sol-like optical semiconductor material are compounded at the preparation of the compound for film formation, water of the dispersion medium is used to hydrolyze the hydrolyzable organosilane, and this hydrolysis is accelerated by the sol-like optical semiconductor material as the acid catalyst. As a result, the partial hydrolysate or the full hydrolysate of the hydrolyzable organosilane is generated.

In the case of adding the sol-like optical semiconductor material using only the organic solvent, the kind of the organic solvent as the dispersion medium is not specifically limited. For example, it is possible to use at least one hydrophilic organic solvent used in the mixed dispersion medium of water and the organic solvent, or at least one hydrophobic organic solvent such as toluene and xylene. In these organic solvents, it is preferred to use methanol. In this case, there are advantages in dispersion stability of optical semiconductor fine particles, and drying characteristics of the dispersion medium at the film formation.

It is preferred that a compounding weight ratio of the optical semiconductor material to the total weight (1) of the solid content in the terms of condensate of the silicone resin and silica that is the solid content in the colloidal silica is 0.01 or more and less than 0.4. When the ratio is less than this range, sufficient photocatalyst performance may not be obtained. On the other hand, when the ratio exceeds this range, there is a tendency of decreasing the film strength. In the above range, excellent film strength is obtained.

It is also preferred that the composition for film formation further contains an organic zirconium. When the organic zirconium is included in the film, the contact angle of water on the film can be easily controlled within the range of 5 to 30°, and more preferably 8 to 25°. In addition, a condensation reaction of the silicone resin can be accelerated at the film formation. As a result, there are advantages that a crosslinking density in the film increases, and the adhesion between the film and the substrate is improved. Moreover, effects of providing hydrophobicity, water-proof and alkali-proof to the film can be achieved.

As the organic zirconium, for example, a compound shown in the following chemical formula (10) can be used.

ZrOₙR³ₘ(OR¹)ₚ (10)

(“m”, “p” are an integer of 0 to 4, and “n” is 0 or 1. In the case of “n”=0, “m+p”=4. In the case of “n”=1, “m+p”=2.)

In the above formula, the functional group “R¹” of the alkoxyl group “OR¹” is the same as the formula (1), (2). “R³” in the formula comprises, for example, C₅H₇O₂ (acetylacetonate complex) or C₆H₉O₃ (ethyl acetoacetate complex). In addition, different kinds of “OR¹” and “R³” may be included in one molecule. In particular, as the organic zirconium, when using at least one of Zr(OC₄H₉)₃(C₅H₇O₂) and Zr(OC₄H₉)₂(C₅H₇O₂)(C₆H₉O₃), it is possible to further improve the film strength. For example, even when the film is formed at a relatively low temperature of 100° C., it is possible to obtain a film strength corresponding to the film formed at the high temperature of 300° C. It is preferred that an additive amount of the organic zirconium is 0.1 to 10 weight % in terms of ZrO₂ with respect to the entire solid contents of the composition for film formation.

In the case of using the composition for film formation, which contains both of the optical semiconductor material and the organic zirconium, it is preferred that a compounding weight ratio of a solid content of the optical semiconductor material to a total weight (1) of the solid content in terms of condensate of the silicone resin and silica as the solid content in the colloidal silica is 0.01 or more and less than 0.4, although it changes in response to the composition of silicone resin. When the ratio is less than this range, sufficient photocatalyst performance may not be obtained. On the other hand, when the ratio exceeds this range, the contact angle of water on the film surface may become less than 5°. Moreover, there is a fear that transparency of the film is lost, or a reduction in film strength occurs.

In the case of using the composition containing the optical semiconductor material and the organic zirconium, it is also preferred that an additive amount of the organic zirconium is in a range of 0.1 to 10 weight % in terms of ZrO₂ with respect to the entire solid contents of the composition for film formation % In this case, it is possible to further improve the effect of maintaining the contact angle. When the additive amount is less than the above range, the above effect may not be sufficiently obtained. On the other hand, when the additive amount is exceeds the above range, the film formation may be difficult because of the occurrence of gelation or agglomeration of the composition.

To obtain the composition for film formation, in which the above described components are uniformly dispersed, it is possible to use a conventional dispersing technique, for example, homogenizer, disper, paint shaker or bead mill.

The antifouling property brought by the film formation is remarkably achieved in the case of forming the film on a translucent substrate. In particular, when using a glass substrate, a temperature range available for the film formation becomes wider, so that the film strength can be easily improved. In addition to the glass substrate, for example, a substrate made of polycarbonate, acrylic resin or polyethylene terephthalate resin may be used.

Prior to the film formation on the substrate, it is preferred to perform a pretreatment (preliminary washing) for increasing the adhesion between the film and the substrate or making uniform painting of the film possible. This pretreatment comprises alkali cleaning, ammonium fluoride cleaning, plasma cleaning, UV cleaning and cerium oxide cleaning.

A method of forming the film is not specifically limited. For example, it is possible to choice appropriate one from conventional methods such as brush painting, spray coating, dipping or dip coating, roll coating, flow coating, curtain coating, knife coating, spin coating, bar coating, deposition and spattering. As described above, the composition for film formation is applied to the substrate, and then heated if necessary, so that curing proceeds by a condensation polymerization reaction of the silicone resin in the composition. As a result, the film formation is completed.

In addition, after the film formation, a subsequent treatment of making the contact angle of water on the film surface within the range of 5 to 30° and preferably 8 to 25° may be carried out. This subsequent treatment comprises steam treatment, alkali treatment, plasma treatment, ultraviolet treatment and polishing. In these subsequent treatments, a desired contact angle of water on the film surface can be obtained by changing treatment conditions such as treatment time and temperature.

In the present invention, excellent antifouling property of the coated article, for example, means a case that when the film formed on the vertical surface of a substrate can maintain the above range of the contact angle for more than 3 months, and preferably more than one year under an outdoor condition that the coated article is exposed to rainfall.

In the antifouling film coated article of the present invention, when contaminants such as fugitive dust in the air adhere to the film in a dried state, and then a large amount of water such as rainfall falls on the film, a layer of water is formed on the film surface to wash away the adhered contaminants. Therefore, there is an advantage of preventing the film surface from contamination. On the other hand, when the amount of water falling on the film surface is small, the contaminants localize at the outer edges of water drops adhered to the film surface. After the rain water is dried, the contaminants may remain on the film surface along flows of the rain water. However, according to the present invention, since the water drops do not excessively spread on the film surface, it is possible to reduce the amounts of contaminants left on the film surface by drying the water drops. When the water drops do not run off, small amounts of contaminants may remains in a scale-like pattern on the film surface after drying. However, in such a case, it will be difficult to clearly recognize the contamination.

The present invention is explained below in details according to Examples. However, the present invention is not limited those Examples. In the following description, “parts” means “parts by weight”, and “%” means “weight percent” unless otherwise specified.

In addition, molecular weight was measured by GPC (Gel Permeation Chromatography). Model Number “HLC8020” manufactured by TOSOH CORPORATION was used as the measuring device. The molecular weight was measured as a corresponding value from an analytical curve prepared by use of standard polyethylene. In addition, average surface roughness was measured by use of an atom force microscope (“Nanopics 1000” manufactured by Seiko Instruments Inc.).

### EXAMPLE 1

356 parts of methanol was added to 208 parts of tetraethoxysilane, and then 18 parts of water and 18 parts of hydrochloric acid of 0.01 mol/L were mixed thereto. A resultant mixture was sufficiently mixed by use of a disper. Next, the obtained solution was heated at 60° C. in a thermostatic chamber for 2 hours to obtain a silicone resin having the weight-average molecular weight of 950.

A titanium oxide sol (dispersion medium: water, solid content: 21%, average primary particle size: 20 nm) was added as an optical semiconductor material to this silicone resin such that a compounding weight ratio of a solid content of titanium oxide to the solid content (1) in terms of condensate of the silicone resin is 0.39. In addition, it was diluted with methanol, so that the solid content is 1%. As a result, a composition for film formation was obtained.

After this composition was left for 1 hour, it was applied to a glass substrate by use of a wire bar coater (No. 10), and then sintered at 200° C. for 10 minutes to obtain an antifouling film coated article of Example 1. From SEM (scanning electron microscope) observation of a fracture surface of this coated article, it was confirmed that the film thickness is 100 nm. In addition, the average surface roughness is 3.4 nm.

### EXAMPLE 2

Colloidal silica (dispersion medium: methanol, particle size: 10˜20 nm, Manufacturer: NISSAN CHEMICAL INDUSTRIES, LTD., Product Number: “MA-ST”) was added to a silicone resin prepared as in the case of Example 1 such that a compounding weight ratio of a solid content of silica to the solid content (1) in terms of condensate of the silicone resin is 4.0. In addition, it was diluted with methanol, so that the solid content is 1%. As a result, a composition for film formation was obtained.

In Example 2, the solid content of colloidal silica is 30 wt %. Therefore, when 10 g of colloidal silica was added, the solid content is 3 g. In addition, the silicone resin used in the present Example is tetraethoxysilane having the molecular weight of 208. When it is completely converted to SiO₂ by removing C₂H₅O, the molecular weight is 60. This is the meaning of “in terms of condensate”. The solid content of the silicone resin of Example 1 corresponds to 10% of 600 parts that is the total of 208 parts of tetraethoxysilane, 356 parts of methanol, 18 parts of water, and 18 parts of hydrochloric acid. That is, “1:4” in Example 2 means the addition of 100 g (solid content 10 g) of the silicone resin having the solid content of 10% and 133.33 g (solid content 40 g) of colloidal silica.

After the thus obtained composition was applied to a glass substrate, and then sintered at 200° C. for 10 minutes to obtain an antifouling film coated article of Example 2. From SEM (scanning electron microscope) observation of a fracture surface of this coated article, it was confirmed that the film thickness is 100 nm. In addition, the average surface roughness is 1.5 nm.

### EXAMPLE 3

A titanium oxide sol (dispersion medium: water, solid content: 21%, average primary particle size: 20 nm) was added as an optical semiconductor material to a silicone resin prepared as in the case of Example 1 such that a compounding weight ratio of a solid content of titanium oxide to the solid content (1) in terms of condensate of the silicone resin is 0.39. In addition, Zr(OC₄H₉)₃(C₅H₇O₂) was added as an organic zirconium to the silicone resin such that a compounding amount of the organic zirconium in terms of ZrO₂ is 1% with respect to the entire solid contents of the composition. Then, it was diluted with methanol, so that the solid content is 1%. As a result, a composition for film formation was obtained.

After the thus obtained composition was applied to a glass substrate, and then sintered at 200° C. for 10 minutes to obtain an antifouling film coated article of Example 3. From SEM observation of a fracture surface of this coated article, it was confirmed that the film thickness is 100 nm. In addition, the average surface roughness is 3.0 nm.

### EXAMPLE 4

A titanium oxide sol (dispersion medium: water, solid content: 21%, average primary particle size: 20 nm) as an optical semiconductor material and colloidal silica (dispersion medium: methanol, particle size: 10˜20 nm, Manufacturer: NISSAN CHEMICAL INDUSTRIES, LTD., Product Number: “MA-ST”) were added to a silicone resin prepared as in the case of Example 1 such that a compounding weight ratio of a solid content of silica to the solid content (1) of titanium oxide is 0.5, and a compounding weight ratio of the total solid contents of the colloidal silica and the titanium oxide sol to the solid content (1) in terms of condensate of the silicone resin is 0.56. Then, it was diluted with methanol, so that the solid content is 1%. As a result, a composition for film formation was obtained.

After the thus obtained composition was applied to a glass substrate, and then sintered at 200° C. for 10 minutes to obtain an antifouling film coated article of Example 4. From SEM observation of a fracture surface of this coated article, it was confirmed that the film thickness is 100 nm. In addition, the average surface roughness is 2.5 nm.

### EXAMPLE 5

A titanium oxide sol (dispersion medium: water, solid content: 21%, average primary particle size: 20 nm) as an optical semiconductor material and colloidal silica (dispersion medium: methanol, particle size: 10-20 nm, Manufacturer: NISSAN CHEMICAL INDUSTRIES, LTD., Product Number: “MA-ST”) were added to a silicone resin prepared as in the case of Example 1 such that a compounding weight ratio of a solid content of silica to the solid content (1) of titanium oxide is 0.5, and a compounding weight ratio of the total solid contents of the colloidal silica and the titanium oxide sol to the solid content (1) in terms of condensate of the silicone resin is 0.56. In addition, Zr(OC₄H₉)₃(C₅H₇O₂) was added as an organic zirconium. Then, it was diluted with methanol, so that the solid content is 1%. As a result, a composition for film formation was obtained. In this Example, a compounding amount of the organic zirconium in terms of ZrO₂ is 1% with respect to the entire solid contents of the composition for film formation.

By the way, in this Example, titanium oxide:silica is 1:0.5, and (titanium oxide+silica):silicone resin is 0.56:1. Therefore, titanium oxide:silica silicone resin is 0.373:0.186:1. In addition, when their solid contents, i.e., 10% of the silicone resin, 30% of silica, 21% of titanium oxide are considered, the weight ratio of the additive amounts is 1.78:0.62:10. Moreover, the molecular weight of Zr(OC₄H₉)₃(C₅H₇O₂) is 409, and the molecular weight of ZrO₂ is 123. Therefore, the addition of 409 g of Zr(OC₄H₉)₃(C₅H₇O₂) corresponds to the addition of 123 g in the terms of ZrO₂. For example, when the entire solid contents is 100 g, and the compounding amount is 1 g (=1%), the additive amount is approximately 3.33 g, which is calculated by 1×409/123.

After the thus obtained composition was applied to a glass substrate, and then sintered at 200° C. for 10 minutes to obtain an antifouling film coated article of Example 5. From SEM observation of a fracture surface of this coated article, it was confirmed that the film thickness is 100 nm. In addition, the average surface roughness is 2.6 nm.

### EXAMPLE 6

Colloidal silica (dispersion medium: methanol, particle size: 10˜20 nm, Manufacturer: NISSAN CHEMICAL INDUSTRIES, LTD., Product Number: “MA-ST”) was added to a silicone resin prepared as in the case of Example 1 such that a compounding weight ratio of a solid content of colloidal silica to the solid content (1) in terms of condensate of the silicone resin is 1.5. In addition, it was diluted with methanol, so that the solid content is 1%. As a result, a composition for film formation was obtained.

After the thus obtained composition was applied to a glass substrate, and then sintered at 200° C. for 10 minutes to obtain an antifouling film coated article of Example 6. From SEM observation of a fracture surface of this coated article, it was confirmed that the film thickness is 100 nm. In addition, the average surface roughness is 1.5 nm.

### COMPARATIVE EXAMPLE 1

A titanium oxide sol (dispersion medium: water, solid content: 21%, average primary particle size: 20 nm) was added as an optical semiconductor material to a silicone resin prepared as in the case of Example 1 such that a compounding weight ratio of a solid content of titanium oxide to the solid content (1) in terms of condensate of the silicone resin is 1.0. In addition, it was diluted with methanol, so that the solid content is 1%. As a result, a composition for film formation was obtained.

After the thus obtained composition was applied to a glass substrate, and then sintered at 200° C. for 10 minutes to obtain an antifouling film coated article of Comparative Example 1. From SEM observation of a fracture surface of this coated article, it was confirmed that the film thickness is 100 nm. In addition, the average surface roughness is 4.5 nm.

### COMPARATIVE EXAMPLE 2

A titanium sol (dispersion medium: water, solid content: 21%, average primary particle size: 20 nm) as an optical semiconductor material and colloidal silica (dispersion medium: water, particle size: 40˜50 nm, Manufacturer: NISSAN CHEMICAL INDUSTRIES, LTD., Product Number: “ST-OL”) were added to a silicone resin prepared as in the case of Example 1 such that a compounding weight ratio of a solid content of silica to the solid content (1) of titanium oxide is 0.5, and a compounding weight ratio of the total solid contents of the colloidal silica and the titanium oxide sol to the solid content (1) in terms of condensate of the silicone resin is 0.67. Then, it was diluted with methanol, so that the solid content is 1%. As a result, a composition for film formation was obtained.

After the thus obtained composition was applied to a glass substrate, and then sintered at 200° C. for 10 minutes to obtain an antifouling film coated article of Comparative Example 2. From SEM observation of a fracture surface of this coated article, it was confirmed that the film thickness is 100 nm. In addition, the average surface roughness is 8.1 nm.

### COMPARATIVE EXAMPLE 3

As Comparative Example 3, a glass substrate without the film formation was used. The average surface roughness of this glass substrate is smaller than 1.0 nm.

Table 1 shows contents of respective components in the film with respect to Examples 1 to 6 and Comparative Examples 1 to 3.

TABLE 1

| | titanium | colloidal | silicone | organic |
|---|---|---|---|---|
| | oxide | silica | resin | zirconium |
| Example 1 | 28.1% | — | 71.9% | — |
| Example 2 | — | 80.0% | 20.0% | — |
| Example 3 | 27.8% | — | 71.2% | 1.0% |
| Example 4 | 24.0% | 12.0% | 64.0% | — |
| Example 5 | 24.2% | 12.1% | 64.6% | 1.0% |
| Example 6 | — | 60.0% | 40.0% | — |
| Comparative | 50.0% | — | 50.0% | — |
| Example 1 | | | | |
| Comparative | 26.7% | 13.3% | 60.0% | — |
| Example 2 | | | | |
| Comparative | — | — | — | — |
| Example 3 | | | | |

(Evaluation Test)

The antifouling film coated articles obtained in Examples 1 to 6 and Comparative Examples 1 and 2, and the glass substrate of Comparative Example 3 were placed outside in a vertical stand configuration, and kept outdoors for 12 months. With respect to these antifouling film coated articles and the glass substrate, a degree of contamination and a change in contamination pattern were periodically checked by visual observation. Evaluations were performed according to the following evaluation standards. Results were shown in TABLES 2 and 3.

In TABLES, “light rainfall” means an amount of rain water where water drops appears on the surface, but no layer of water can be formed. On the other hand, “heavy rainfall” means an amount of rain water where the entire surface uniformly got wet, so that the layer of water can be formed.

The evaluation standard for the degree of contamination:

◯: Contamination can not be recognized.

Δ: Contamination can be slightly observed.

X: Noticeable contamination appears.

The evaluation standard for the contamination pattern:

CL1: Contamination appeared in a scale-like pattern, as shown in FIG. 2. FIG. 2 shows an appearance of the antifouling film coated article of Comparative Example 3 observed after the elapse of 12 months.

CL2: Contamination appeared along flows of rain water, as shown in FIG. 3. FIG. 3 shows an appearance of the antifouling film coated article of Comparative Example 1 observed after the elapse of 12 months.

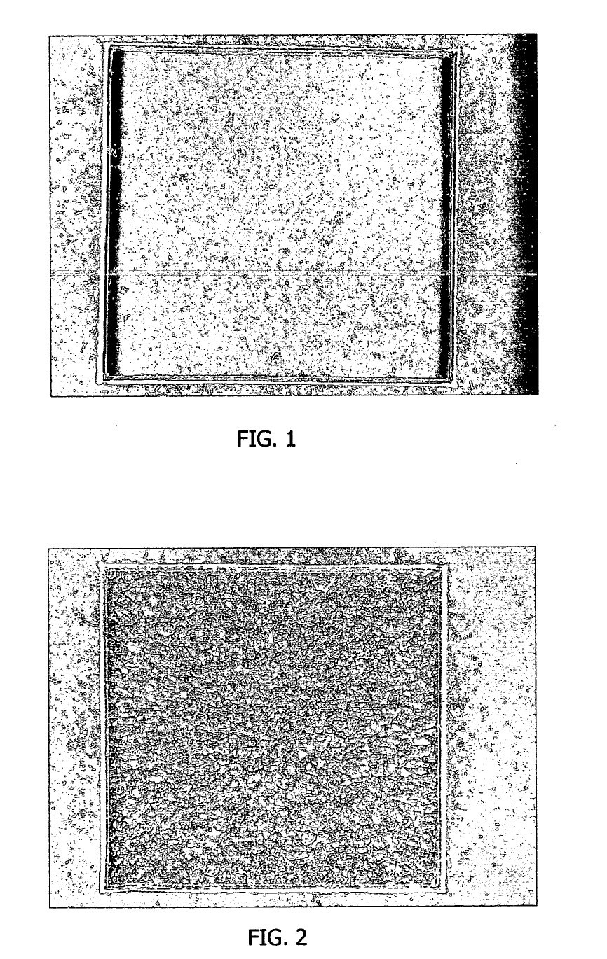

As shown in TABLES 2 and 3, each of Examples 1 to 6 demonstrates higher antifouling property than the Comparative Examples 1 to 3. For example, in Example 1, there is no contamination even after the elapse of 12 months, as shown in FIG. 1. On the contrary, in the Comparative Example 3, contamination appeared in the scale-like pattern, as shown in FIG. 2. In the Comparative Example 1, contamination appeared in streaks along the flows of rain water, as shown in FIG. 3. Thus, noticeable contamination could be recognized.

In addition, with respect to Example 1 and Comparative Examples 1 to 3, the adhesion of raindrops and the contamination pattern were observed in details after they were exposed to the outdoors for 3 months and 6 months. Results were shown in TABLE 4.

TABLE 2

| | Observation day | | | | |
|---|---|---|---|---|---|
| | 1 week | 1 month | 3 months | 6 months | 12 months |
| | Rainfall on the day | | | | |
| | before the observation day | | | | |
| | | light | light | heavy | light |
| | — | rainfall | rainfall | rainfall | rainfall |
| Example 1 | | | | | |
| Ra = 3.4 nm | | | | | |
| Contact angle | 8° | 17° | 10° | 18° | 15° |
| Degree of | ◯ | ◯ | ◯ | ◯ | ◯ |
| contamination | | | | | |
| Contamination | — | — | — | — | — |
| pattern | | | | | |
| Example 2 | | | | | |
| Ra = 1.5 nm | | | | | |
| Contact angle | 8° | 15° | 21° | 23° | 20° |
| Degree of | ◯ | ◯ | ◯ | ◯ | ◯ |
| contamination | | | | | |
| Contamination | — | — | — | — | — |
| pattern | | | | | |
| Example 3 | | | | | |
| Ra = 3.0 nm | | | | | |
| Contact angle | 6° | 6° | 8° | 9° | 7° |
| Degree of | — | Δ | Δ | ◯ | Δ |
| contamination | | | | | |
| Contamination | — | CL2 | CL2 | — | CL2 |
| pattern | | | | | |
| Example 4 | | | | | |
| Ra = 2.5 nm | | | | | |
| Contact angle | 6° | 12° | 10° | 15° | 18° |
| Degree of | ◯ | ◯ | ◯ | ◯ | ◯ |
| contamination | | | | | |
| Contamination | — | — | — | — | — |
| pattern | | | | | |
| Example 5 | | | | | |
| Ra = 2.6 nm | | | | | |
| Contact angle | 10° | 11° | 15° | 10° | 12° |
| Degree of | ◯ | ◯ | ◯ | ◯ | ◯ |
| contamination | | | | | |
| Contamination | — | — | — | — | — |
| pattern | | | | | |
| Example 6 | | | | | |
| Ra = 1.8 nm | | | | | |
| Contact angle | 18° | 20° | 25° | 27° | 28° |
| Degree of | ◯ | ◯ | Δ | ◯ | Δ |
| contamination | | | | | |
| Contamination | — | — | CL1 | — | CL1 |
| pattern | | | | | |

TABLE 3

| | Observation day | | | | |
|---|---|---|---|---|---|
| | 1 week | 1 month | 3 months | 6 months | 12 months |
| | Rainfall on the day | | | | |
| | before the observation day | | | | |
| | | light | light | heavy | light |
| | — | rainfall | rainfall | rainfall | rainfall |
| Comparative | | | | | |
| Example 1 | | | | | |
| Ra = 4.5 nm | | | | | |
| contact angle | smaller | 3° | smaller | smaller | 4° |
| | than 1° | | than 1° | than 1° | |
| Degree of | ◯ | Δ | X | ◯ | X |
| contamination | | | | | |
| Contamination | — | CL2 | CL2 | — | CL2 |
| pattern | | | | | |
| Comparative | | | | | |
| Example 2 | | | | | |
| Ra = 8.1 nm | | | | | |
| Contact angle | 6° | 10° | 12° | 10° | 15° |
| Degree of | ◯ | Δ | X | ◯ | X |
| contamination | | | | | |
| Contamination | — | CL2 | CL2 | — | CL2 |
| pattern | | | | | |
| Comparative | | | | | |
| Example 3 | | | | | |
| Ra = smaller | | | | | |
| than 1.0 nm | | | | | |
| Contact angle | 35° | 40° | 55° | 62° | 69° |
| Degree of | ◯ | X | X | X | X |
| contamination | | | | | |
| Contamination | — | CL1 | CL1 | CL1 | CL1 |
| pattern | | | | | |

TABLE 4

| | light rainfall | heavy rainfall |
|---|---|---|
| Example 1 | There was no noticeable | The surface uniformly got wet, |
| | contamination. | and contamination ran off. |
| Comparative | Noticeable contamination | The surface uniformly got wet, |
| Example 1 | appeared in streaks along | and contamination ran off. |
| | flows of rainwater. | |
| Comparative | Noticeable contamination | The surface uniformly got wet, |
| Example 2 | appeared in streaks along | and contamination ran off. |
| | flows of rainwater. | |
| Comparative | Raindrops adhered. After | Raindrops adhered. After drying, |
| Example 3 | drying, noticeable | noticeable contamination |
| | contamination appeared | appeared in a scale-like pattern. |
| | in a scale-like pattern. | |

### INDUSTRIAL APPLICABILITY

As described above, the antifouling film coated article of the present invention is obtained by forming a film of the silicone resin material on the substrate, and characterized in that the contact angle of water on the film is in a range of 5 to 30°, more preferably 8 to 25°, and the average surface roughness of the film is 5 nm or less. Thereby, it is possible to stably maintain good antifouling property over an extended time period regardless of the amount of rainfall falling thereon. In particular, it is preferred that the silicone resin material of the film is a composition containing colloidal silica and a silicone resin that is at least one of a partial hydrolysate and full hydrolysate of 4-functional hydrolyzable organosilane. Since the hydrophilicity of the film is maintained by the presence of colloidal silica, it becomes easy to stably maintain the contact angle of water on the film in the above range over the extended time period. In addition, it is preferred that the composition further contains organic zirconium and/or an optical semiconductor material such as titanium oxide. When using the organic zirconium, it is possible to easily control the contact angle of water on the film. On the other hand, when using the optical semiconductor material, an antifouling effect brought by photocatalysis is obtained.

Thus, according to the antifouling film coated article of the present invention, it is possible to prevent the occurrence of contamination, even when the coated article is weathered by wind and water for an extended time period in outdoor environment. In addition, since the number of times of operations for washing the contamination can be reduced, it is possible to save the maintenance cost. Therefore, the present invention is of great value in the industrial application.

1. An antifouling film coated article having a film of a silicone resin material on a substrate, wherein a contact angle of water on said film is in a range of 5 to 30°, and an average surface roughness of said film is 5 nm or less.

2. The antifouling film coated article as set forth in claim 1, wherein the contact angle of water on said film is in a range of 8 to 25°.

3. The antifouling film coated article as set forth in claim 1, wherein the silicone resin material of said film is a composition containing colloidal silica and a silicone resin that is at least one of a partial hydrolysate and full hydrolysate of 4-functional hydrolyzable organosilane.

4. The antifouling film coated article as set forth in claim 3, wherein said composition contains the colloidal silica such that a weight ratio of a solid content of silica to the solid content in terms of condensate of the silicone resin is in a range of 0.01 to 9.

5. The antifouling film coated article as set forth in claim 3, wherein said composition further contains an organic zirconium.

6. The antifouling film coated article as set forth in claim 5, wherein said composition contains 0.1 to 10 parts by weight of the organic zirconium in terms of ZrO₂ with respect to 100 parts by weight of the entire solid contents of said composition.

7. The antifouling film coated article as set forth in claim 3, wherein said composition further contains an optical semiconductor material.

8. The antifouling film coated article as set forth in claim 7, wherein a compounding ratio by weight of the optical semiconductor material to a total weight of the solid content in the terms of condensate of the silicone resin and silica as the solid content of the colloidal silica is 0.01 or more and less than 0.4.

9. The antifouling film coated article as set forth in claim 3, wherein said composition contains a optical semiconductor material such that a compounding ratio by weight of the optical semiconductor material to the solid content in terms of condensate of the silicone resin is 0.01 or more and less than 0.4, and further contains 0.1 to 10 parts by weight of an organic zirconium in terms of ZrO₂ with respect to 100 parts by weight of the entire solid contents of said composition.

10. The antifouling film coated article as set forth in claim 1, wherein said substrate is made of glass.
